(19) United States
(12) Patent Application Publication
(10) Pub. No.: US 2007/0169371 A1
(43) Pub. Date: Jul. 26, 2007

(54) Ultra-sonic fast hair dryer

(76) Inventors: Jun Hua Feng, Hsin-Chu City (TW); Tze Yao Tsai, Hsin-Chu City (TW); Li Yu Wang, Taipei (TW); Yu Fen Lin, Hsin-Chu City (TW)

Correspondence Address: Ms. Li Yu Wang;9F-1, No. 266, Ming-Chung Rd., Hsin-Chu City, 300, TW

(21) Appl. No.: 11/335,650

(22) Filed: Jan. 20, 2006

(51) Int. Cl. F26B 3/34

(52) U.S. Cl. 34/279

(57) ABSTRACT

An apparatus is made from the material that can conduct the ultra-sonic wave. The ultra-sonic wave can oscillate the large water molecule into smaller ones or smash them. Make the apparatus as the comb teeth and integrate it with the traditional hair dryer to help to dry the wet hair in a very short time, 3˜5 minutes.

### CROSS-REFERENCE TO RELATED APPLICATIONS

I claim the benefit of this application is to apply the theory of ultra-sonic wave on the hair dryer in order to dry the wet hair in a very short time which is about 3˜5 minutes.

### BACKGROUND OF THE INVENTION

In many years people only use the towel and any kind of high power hair dryer to dry the wet hair. For those people with long hair, it will take about 30 minutes or more to dry and style the wet hair. It takes too long to do this if those persons are in a hurry. Therefore, based on this reason, it is necessary to invent a new type of hair dryer to speed on the hair drying.

### BRIEF SUMMARY OF THE INVENTION

One Ultra-Sonic structural product, the material can conduct ultra-sonic wave, the utilization of the shape can comb the hair or contact the hair closely. To apply the ultra-sonic wave with proper power, the ultra-sonic wave can separate large water molecular into small water molecular or smash water molecular on the wet hair. Integrated this advantage with the traditional hair dryer, people can evaporate or smash the water molecular more easily and get the benefit of hair drying fast.

### BRIEF DESCRIPTION OF THE SEVERAL VIEWS OF THE DRAWINGS

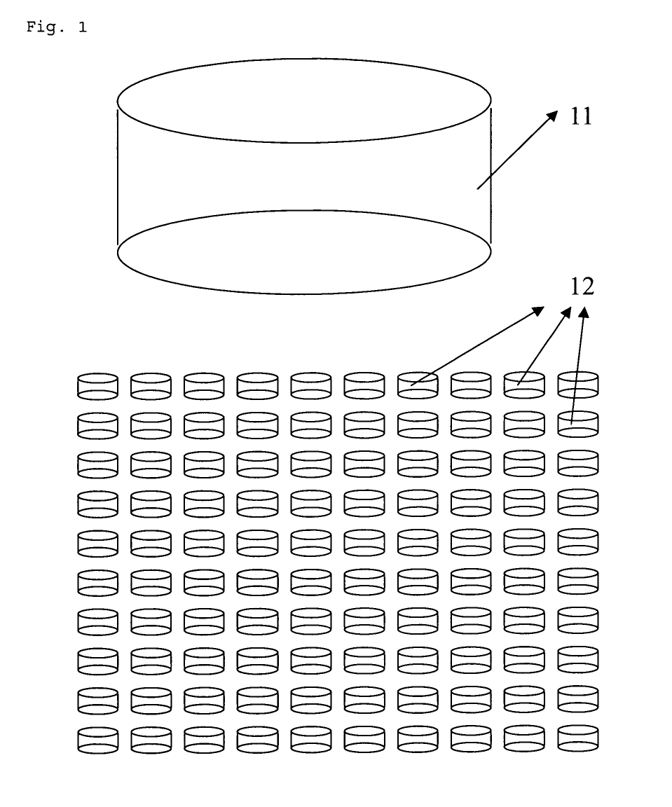

1. FIG. 1 are shown a drip of 1 cc water and 100 drips of 0.01 cc water. That means as the water molecular is decomposed into many smaller water molecular, the contact areas are increasing and those smaller water molecular can be evaporated more rapidly.

2. FIG. 2 is a system structure of this invention.
(16) is a black box of the power system, which can be DC, AC or battery power.
(17) is a black box of the power supply control circuit.

This part controls the whole system on/off, LED display board, output voltage and the frequency of the ultra-sonic wave.
(18) is a black box of the oscillating circuit, which controls the oscillating frequency, the magnitude and the amplitude of the output current.
(19) is a black box of ultra-sonic generating circuit.
(15) is a comb tooth made of the material, which can conduct the ultra-sonic wave. Via those comb teeth, the ultra-sonic wave can be conducted to the wet hair to decompose the large water molecular to smaller ones.

3. FIG. 3 is a large scaled picture of a comb tooth.
(15) It is made of the stainless steel that can conduct the ultra-sonic wave.
(20) On the top of a comb tooth, an isolated material is used to prevent the ultra-sonic or electrical wave to hurt human body.

### DETAILED DESCRIPTION OF THE INVENTION

In FIG. 1, it takes about 30 minutes to evaporate 1 drip of 1 cc water. However, it only can take less than 1 minute to evaporate 100 drips of 0.01 cc water. Therefore, by applying this theory, it will save a lot of time to evaporate the water as decomposing 1 drip of 1 cc water into 100 drips of 0.01 cc water. This invention is to fulfill this theory into reality.

FIG. 2 represents a functional block diagram of this invention. This diagram describes this invention utilizes the function of ultra-sonic wave to establish the prototype applied to decompose the water on the wet hair.

In this invention, the material (15) (like stainless steel) that can conduct the ultra-sonic wave is used to make the comb teeth. The ultra-sonic wave generated from the ultra-sonic generator can be pass into the wet hair via those comb teeth. Operating at the proper frequency, the ultra-sonic wave can oscillate the water molecular on the wet hair into smaller ones or smash them. Then, integrated with the traditional hair dryer, the wet hair can be dried in a very short time by the heat from the hair dryer.

Considering the side effect of the skin contact with the comb teeth directly, the isolated material or the material that can not conduct the ultra-sonic wave is used to make the top parts of these comb teeth in the invention shown in FIG. 3. For example, use the recycled plastic material to make the top parts of the comb teeth. It guarantees the safety of this invention.

1. The material that can conduct the ultra-sonic wave makes an apparatus. This apparatus comprising can conduct the ultra-sonic wave to decompose or smash the water on the wet hair.

2. According to the apparatus claimed on first item, whether this apparatus is individually produced or integrated into a appliance (like a conventional hair dryer) as a single product, it shall be covered by the claim 1 as long as the whole (or partly) structure or the functionality of this apparatus consists of the contents identified on the claim 1.

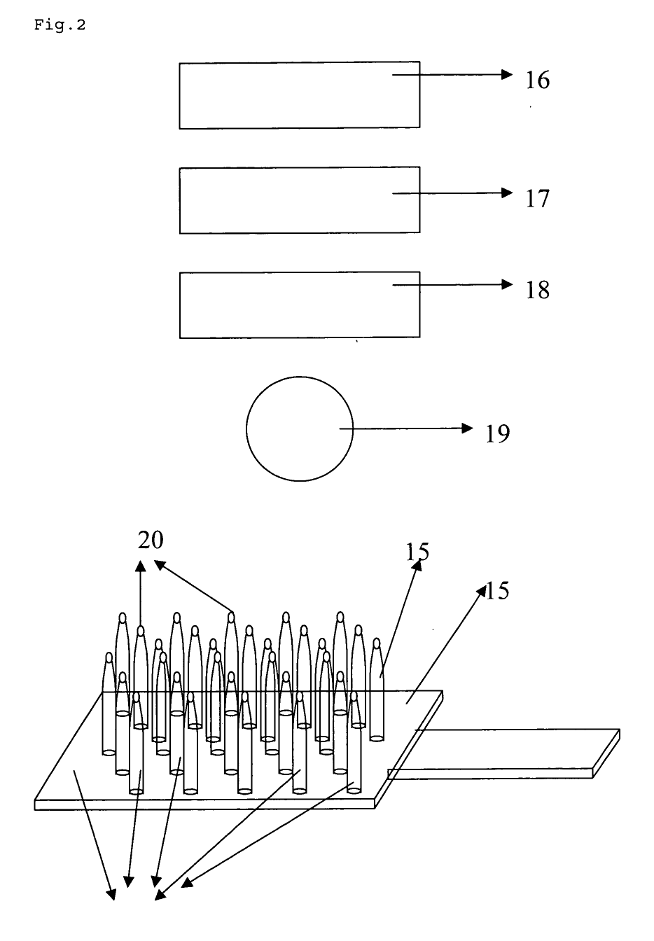

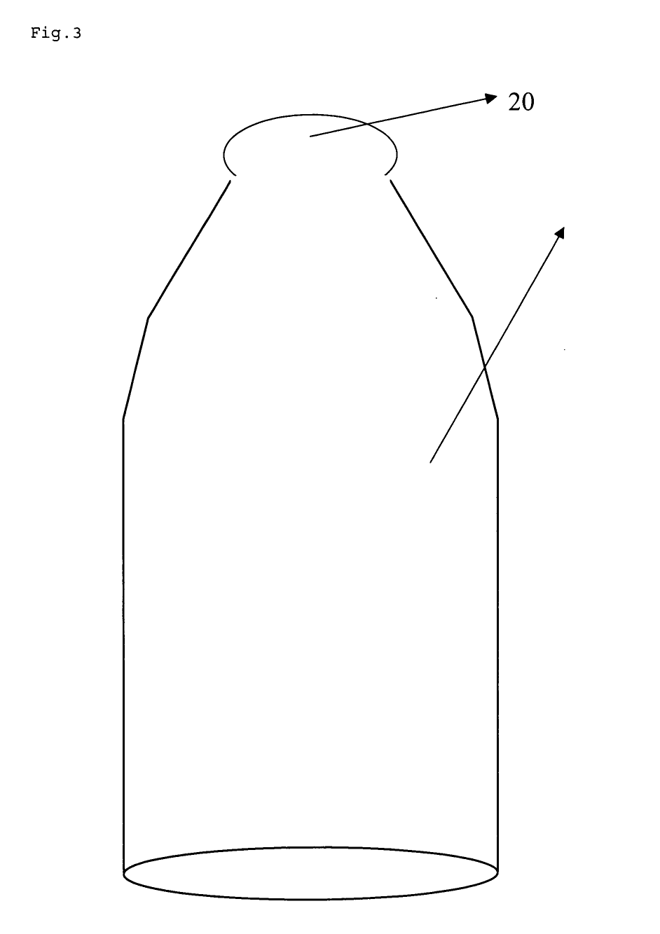

3. According to the apparatus claimed on first item, use the isolated material or the material that can not conduct the ultra-sonic wave to make the top part of this apparatus which contact with the skin directly (like the comb tooth) shown in FIG. 2-20.
